(19) United States
(12) Patent Application Publication
(10) Pub. No.: US 2009/0150665 A1
(43) Pub. Date: Jun. 11, 2009

(54) Interworking 802.1 AF Devices with 802.1X Authenticator

(75) Inventors: John Kaippallimalil, Richardson, TX (US); Yun Pu, Nanjing (CN); Ruobin Zheng, Shenzhen (CN)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/327,598

(22) Filed: Dec. 3, 2008

Related U.S. Application Data
(60) Provisional application No. 61/012,293, filed on Dec. 7, 2007.

(51) Int. Cl. G06F 21/00; H04W 84/02; H04L 9/00; H04L 12/56

(52) U.S. Cl. 713/153; 370/338; 370/389; 726/12

(57) ABSTRACT

An apparatus comprising a supplicant proxy port authorization entity (PAE) configured to communicate with a user equipment (UE) and a network, wherein the supplicant proxy PAE causes a communication path to forward or block communications between the UE and the network. Included is a network component comprising at least one processor configured to implement a method comprising authenticating a UE with a network using an Institute of Electrical and Electronics Engineers (IEEE) 802.1X protocol, and exchanging a secure key with the UE using an IEEE 802.1 AF protocol. Also included is a method comprising authenticating a user UE configured for a first authentication protocol with a network configured for a second authentication protocol using a port entity configured for the first authentication protocol and the second authentication protocol, and securing the UE's access to the network by completing a security key agreement using the first authentication protocol.

### CROSS-REFERENCE TO RELATED APPLICATIONS

The present application claims priority to U.S. Provisional Patent Application Ser. No. 61/012,293 filed Dec. 7, 2007 by John Kaippallimalil et al. and entitled “Interworking 802.1AF Devices with 802.1X Authenticator,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The Institute of Electrical and Electronics Engineers (IEEE) standards 802.1X and 802.1 AF are two protocols that address network authentication and access control in Ethernet or similar networks. IEEE 802.1X is the older of the two protocols and is more widely adopted. The IEEE 802.1X standard provides an authentication mechanism to devices that request to connect to a local area network (LAN) port by establishing a point-to-point connection upon successful authentication or preventing access to the port if authentication fails. The standard can be used with roaming or wireless devices compatible with the IEEE 802.11 standard for wireless LAN (WLAN) access and is based on the Extensible Authentication Protocol (EAP), which is a universal authentication framework used in wireless networks and point-to-point connections. The IEEE 802.1X standard describes communications between a supplicant, such as a software on a client device or laptop, an authenticator, such as a wired Ethernet switch or wireless access point, and an authentication server, such as a Remote Authentication Dial in User Service (RADIUS) protocol server. Accordingly, the supplicant provides credentials, such as passwords or digital certificates, to the authenticator, which in turn forwards the credentials to the authentication server for verification. If the credentials are valid based on the authentication server database information, the supplicant is allowed access the network. The IEEE 802.1 AF standard adds a key exchange mechanism or keying to the authentication process to provide path confidentiality, data origin integrity, and authentication means in more complex network topologies, for example where the authenticator is not adjacent or at a next hop from the supplicant.

### SUMMARY

In one embodiment, the disclosure includes an apparatus comprising a supplicant proxy port authorization entity (PAE) configured to communicate with a user equipment (UE) and a network, wherein the supplicant proxy PAE causes a communication path to forward or block communications between the UE and the network.

In another embodiment, the disclosure includes a network component comprising at least one processor configured to implement a method comprising authenticating a UE with a network using an IEEE 802.1X protocol, and exchanging a secure key with the UE using an IEEE 802.1 AF protocol.

In yet another embodiment, the disclosure includes a method comprising authenticating a UE configured for a first authentication protocol with a network configured for a second authentication protocol using a port entity configured for the first authentication protocol and the second authentication protocol, and securing the UE's access to the network by completing a security key agreement using the first authentication protocol.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an access network edge architecture.

FIG. 2 is a schematic diagram of an embodiment of an IEEE 802.1 AF and IEEE 802.1X interwork architecture.

FIG. 3 is a schematic diagram of another embodiment of an IEEE 802.1 AF and IEEE 802.1X interwork architecture.

FIG. 4 is a table illustrating an embodiment of a plurality of EAP over LAN (EAPOL) packets types.

FIG. 5 is a flowchart of an embodiment of an IEEE 802.1 AF and IEEE 802.1X interworking method.

FIG. 6 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for interworking a device configured for IEEE 802.1 AF authentication with a network edge configured for IEEE 802.1X authentication to provide UE access to a network. Specifically, a router or residential gateway (RG) may communicate with the UE using the IEEE 802.1 AF protocol and with the network edge using the IEEE 802.1X protocol to authenticate the UE and authorize its access to the network. The RG may comprise a PAE and a key agreement entity (KaY). The supplicant proxy PAE may forward EAPOL packets between the UE and the network edge, and open or close a switch to allow or block a connection between the UE and network edge based on the authentication result. The KaY may complete a shared key exchange between the UE and the RG to establish a secure session and encrypt the packets forwarded along a path between the UE and the RG. The shared key may be generated between the UE and the RG or between the UE and a Key Server coupled to the RG.

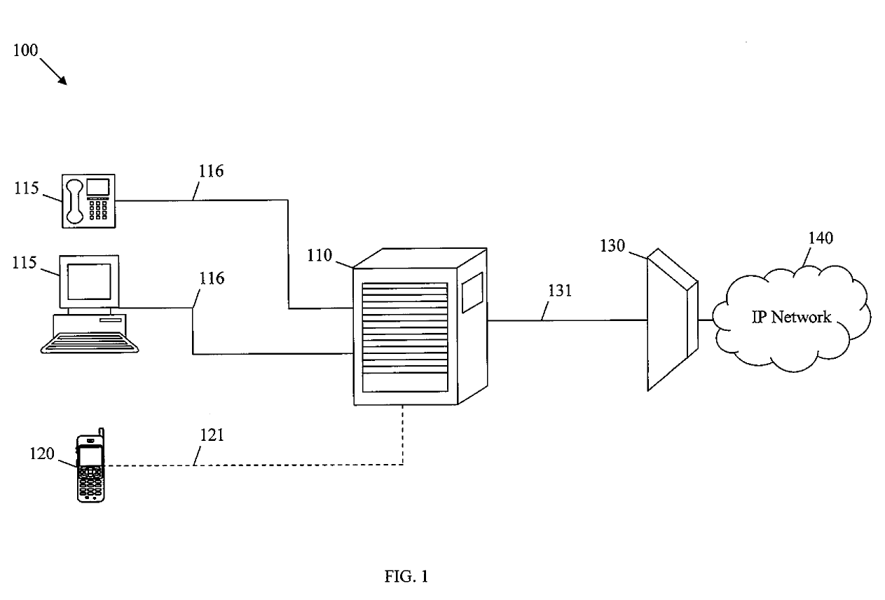

FIG. 1 illustrates one embodiment of an access network edge architecture 100. The access network edge architecture 100 may comprise an RG 110, at least one first UE 115, at least one second UE 120, and a Layer two (L2) Edge 130, which may be coupled to a network 140, such as an access network or an Internet Protocol (IP) network. Accordingly, the first UE 115 and the L2 Edge 130 may be coupled to the RG 110 via a wired connection, and the second UE 120 may establish a wireless connection with the RG 110.

In an embodiment, the RG 110 may be any device, component or network that allows the first UE 115 and the second UE 120 to communicate with the network 140 via the L2 Edge 130. For example, the RG 110 may be an IP router, such as a Media Access Gateway (MAG) or an Access Service Network Gateway (ASN-GW). Alternatively, the RG 110 may be as a customer premises equipment (CPE) router or any router equipment located at a subscriber's premises and that communicates with the network 140. For instance, the RG 110 may be a digital subscriber line (DSL) modem, a cable modem, or a set-top box. In another embodiment, the RG 110 may be a node that forwards IP version 4 (IPv4) and/or IP version 6 (IPv6) packets to and from the first UE 115 and the second UE 120. In an embodiment, the RG 110 may be updated or reconfigured regularly to implement previous communication protocols, including IEEE 802.1X and current communication protocols, including the IEEE 802.1 AF.

In an embodiment, the first UE 115 may be located at a customer premises or at a local access network in communication with the RG 110. The first UE 115 may be any device capable of transmitting or receiving signals to and from the RG 110, such as electrical or optical signal. The first UE 115 may create, send, or receive the signals using a fixed link 116, such as a wired cable or a fiber optic cable, between the first UE 115 and the RG 110. In an embodiment, the fixed link 116 may be an Ethernet link or an Asynchronous Transfer Mode (ATM) link. The first UE 115 may be a fixed device, including a personal computer (PC) such as a desktop computer, a telephone such as a voice over IP (VoIP) telephone, or a set top box. Alternatively, the first UE 115 may be a portable device, such a laptop computer, or a cordless phone, which may use the fixed link 116 to communicate with the RG 110. In an embodiment, the first UE 115 may be updated or reconfigured less frequently than the RG 110, and hence may not implement all the current communication protocols of the RG 110. For instance, the first UE 115 may use IEEE 802.1X to establish authentication, via the RG 110, with the L2 Edge 130 and the network 140.

In an embodiment, the second UE 120 may be any user mobile device, component, or apparatus that communicates with the RG 110 using a wireless link 121. For example, the second UE 120 may be a mobile phone, a personal digital assistant (PDA), a portable computer, or any other wireless device. The second UE 120 may comprise an infrared port, a Bluetooth interface, an IEEE 802.11 compliant wireless interface, or any other wireless communication system that enables the second UE 120 to communicate wirelessly with the RG 110. As such, the wireless link 121 may be an IEEE 802.11 link, a Wi-Fi link, a Bluetooth link, a Worldwide Interoperability for Microwave Access (WiMAX) link, a near field communication (NFC) link, an Infrared Data Association (IrDa) link, or any other communication link established using wireless technology. In an embodiment, the second UE 120 may be updated or reconfigured more frequently than the first UE 115, and hence may implement some of the current communication protocols of the RG 110, which may not be used by the first UE 115. For instance, the second UE 120 may use IEEE 802.1 AF to establish authentication with the RG 110.

In an embodiment, the L2 Edge 130 may be any device that forwards communications between the RG 110 and the network 140. For example, the L2 Edge 130 may be a DSL Access Multiplexer (DSLAM) or a BRAS as defined by the Broadband Forum or a Cable Modem Termination Server (CMTS). The L2 Edge 130 may comprise bridges, switches, routers, or combinations thereof. For instance, the RG 110 may comprise a Back Bone Edge Bridge (BEB), a Provider Edge Bridge (PEB), a Provider Core Bridge (PCB), or a user network interfaces (UNI). Alternatively, the L2 Edge 130 may be a point-oriented wire-line node, such as a DSL connection or a provider network edge device. The L2 Edge 130 may be coupled to the RG 110 via a fixed link 131 and similarly may be coupled via another fixed link to the network 140, and may forward communications between the two using the fixed links. Additionally, the L2 Edge 130 may exchange authentication information with the RG 110 using the IEEE 802.1X protocol and with an authentication server, such as an authentication, authorization, and accounting (AAA) server, using a remote authentication protocol, such as a RADIUS protocol or a DIAMETER protocol.

In an embodiment, the network 140 may be any type of network that exchanges data packets with the L2 Edge 130, the RG 110, the first UE 115, and the second UE 120. For example, the network 140 may be a Packet Switched Network (PSN), an intranet, the Internet, or a local area network (LAN). Alternatively, the network 140 may be an IP network, an Ethernet transport network, a backbone network, an access network, an optical network, a wire-line network, an Institute of Electrical and Electronics Engineers (IEEE) 802 standard network, a wireless network, or any other network.

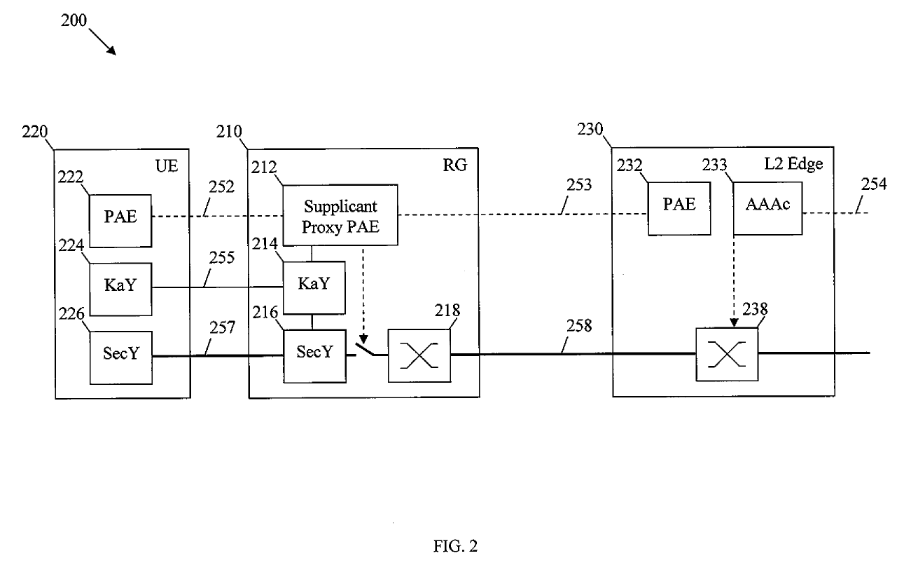

FIG. 2 illustrates an embodiment of an IEEE 802.1 AF and IEEE 802.1X interwork architecture 200, which may be used to authenticate a UE configured for IEEE 802.1 AF authentication with a network or a network edge configured for IEEE 802.1X authentication. The IEEE 802.1 AF and IEEE 802.1X interwork architecture 200 may comprise an RG 210, a UE 220, and an L2 Edge 230, which may be configured substantially similar to the corresponding components of the access network edge architecture 100. The RG 210 may comprise a supplicant proxy PAE 212, a KaY 214, a media access control (MAC) security entity (SecY) 216, and a switch 218, which may be configured as shown in FIG. 2. The UE 220 may comprise a PAE 222, a KaY 224, and a SecY 226, which may be configured as shown in FIG. 2. The PAE 222, the KaY 224, and the SecY 226 may communicate with their corresponding entities at the RG 210 using a connection 252, a connection 255, and a connection 257, respectively, which may be wireless connections and may be part of a single wireless connection. The L2 Edge 230 may comprise a PAE 232 that may communicate with the supplicant proxy PAE 212 using a connection 253, which may be an electrical, optical, or wireless connection. Additionally, the L2 Edge 230 may comprise a switch 238 located between the switch 218 and the network and an AAA client (AAAc) 233 that may communicate with the network using a connection 254. The switch 230 may be connected to the switch 218 via a wired connection 258. The wireless connection 257 between the SecY 226 and the SecY 216, and the wired connection 258 between the switch 218 and the switch 238 may be used to establish a communication path between the UE 220, the RG 210, the L2 Edge 230, and the network.

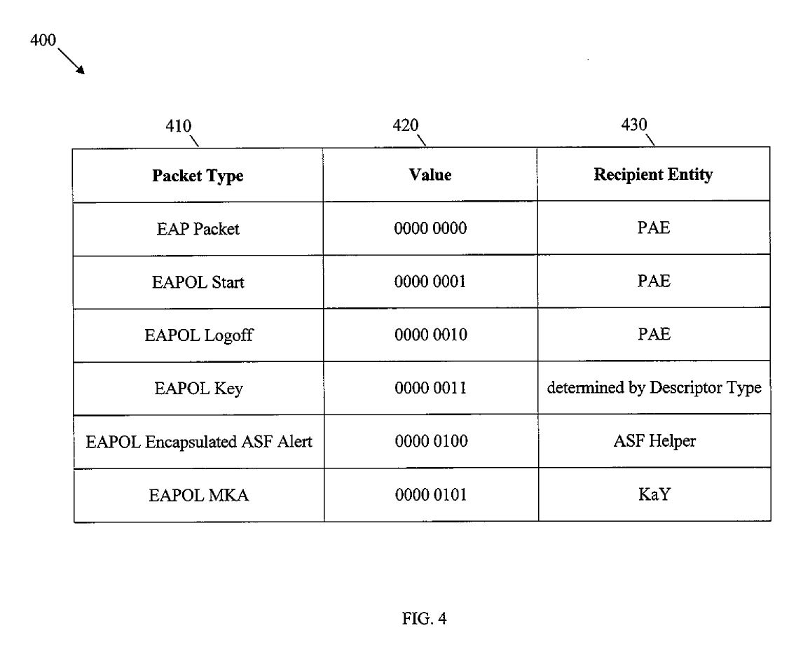

The supplicant proxy PAE 212 may provide the UE 220 authentication and authorization access to the network via the L2 Edge 230, according to the IEEE 802.1X protocol. As such, the supplicant proxy PAE 212 may forward a plurality of EAPOL packets between the UE 220 and the L2 Edge 230. EAPOL may be an encapsulation format, which may be used to transport EAP messages, other authentication exchanges, key agreement exchanges, or combinations thereof, and to forward such information using a LAN MAC service. For instance, the supplicant proxy PAE 212 may receive a plurality of EAPOL protocol data units (PDUs) from the PAE 222 using the connection 252 and the IEEE 802.1 AF protocol. The received EAPOL PDUs may be formatted according to the IEEE 802.1 AF protocol. The supplicant proxy PAE 212 may convert, update, or modify the EAPOL PDUs and forward them to the PAE 232 using the connection 253 and the IEEE 802.1X protocol. Examples of these EAPOL PDUs are shown in FIG. 4.

To process the authentication information in the EAPOL PDUs, the PAE 232 may communicate with the AAAc 233. The AAAc 233 may communicate with an AAA server and implement an AAA protocol that defines various mechanisms and policies for authentication, authorization, and accounting. Some authentication information may be forwarded between the AAAc 233 and the AAA server via the network, e.g. connection 254, using the RADIUS or DIAMETER protocols. For instance, the AAAc 233 may verify a claimed identity for the UE 220, by matching a digital identity, such as a network address or credentials corresponding to the UE 220, such as passwords, one-time tokens, digital certificates, or phone numbers to a client information database in the network. Additionally, the AAAc 233 may determine if a particular right, such as access to some resource, can be granted or authorized to the UE 220. Authorization may be based on restrictions, for example time-of-day restrictions, physical location restrictions, or restrictions against multiple logins by the UE 220. Additionally, the AAAc 233 may track usage or allocation of network resources to the UE 220, which may be used for accounting, management, planning, or other purposes. After processing the authentication information, the AAAc 233 may control the switch 238 to close or open based on authentication success or failure. By opening or closing the switch 238, the L2 Edge 230 may allow or block communications, respectively, between the RG 210 and the network.

Additionally, after the AAAc 233 authentication, the PAE 232 may reply to the supplicant proxy PAE 212 with a success or failed response. Based on authentication success or failure, the supplicant proxy PAE 212 may control the switch 218 to close or open to allow or block communications, respectively, between the UE 220 and the network via the wireless connection 257. Additionally, the supplicant proxy PAE 212 may be configured to provide the UE 220 a port-based network access. For instance, the supplicant proxy PAE 212 may be associated with a port, which may be used to connect the UE 220 to the L2 Edge 230, and enable communications between the two. The supplicant proxy PAE 212 may also be associated with a plurality of ports, which may be designated as “trusted” or “untrusted” ports. The “trusted” ports may be connected via fixed or wireless links that may have been previously authenticated or trusted and used by a plurality of UEs to access the network. The “untrusted” ports may be reserved for unauthenticated wireless connections, wireless or roaming devices, such as the UE 220, or both, to establish communications upon successful authentication. In an embodiment, the ports may be designated as “untrusted” prior to authentication and may redesignated as “trusted” upon successful authentication.

The KaY 214 may provide a shared key between the UE 220 and the RG 210, which may be used to secure a communication session between the UE 220 and the RG 210. As such, the KaY 214 and the KaY 224 may complete a key exchange according to the IEEE 802.1 AF protocol. In an embodiment, the KaY 214 and the KaY 224 may use a MAC security key agreement (MKA) protocol to discover associations and agree on at least one shared key to secure the communication session. For instance, the KaY 214 and the KaY 224 may exchange a plurality of MKA PDUs, which may be EAPOL PDUs, using the connection 255 and the IEEE 802.1 AF protocol. Further, the KaY 214 and the KaY 224 may use a LAN MAC service to exchange the MKA PDUs.

When the key exchange agreement is completed, the SecY 216 may provide the secure session between UE 220 and the RG 210. As such, the SecY 216 and the SecY 226 may use the shared key exchanged between the KaY 214 and the KaY 224 to encrypt the payload packets that are forwarded along the connection 257.

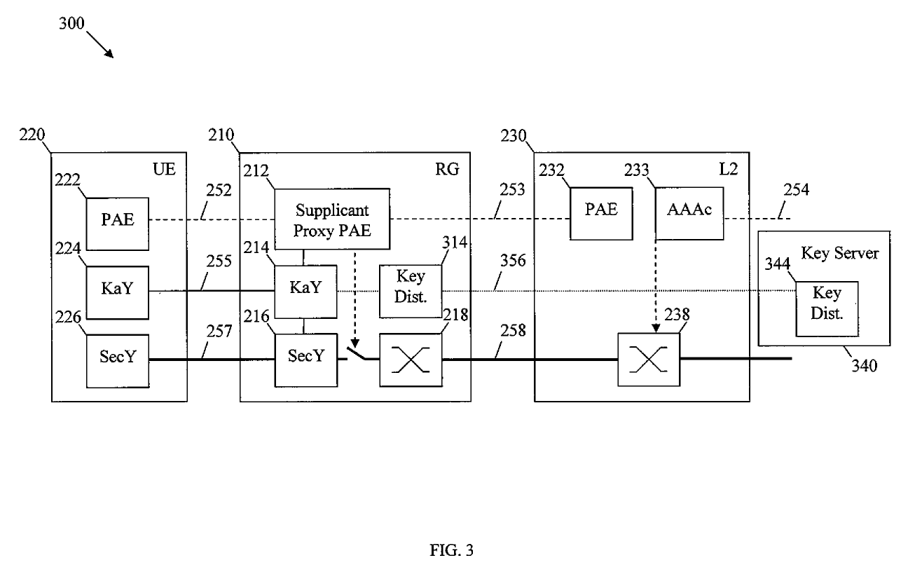

FIG. 3 illustrates another embodiment of an IEEE 802.1 AF and IEEE 802.1X interwork architecture 300 to authenticate a UE configured for IEEE 802.1 AF authentication with a network or a network edge configured for IEEE 802.1X authentication. The IEEE 802.1 AF and IEEE 802.1X interwork architecture 300 may be configured substantially similar to the IEEE 802.1 AF and IEEE 802.1X interwork architecture 200. As such, the IEEE 802.1 AF and IEEE 802.1X interwork architecture 300 may comprise the same components, which may be configured as shown in FIG. 3.

However, the RG 210 may comprise a Key Distributor 314, which may be coupled to the KaY 214. Additionally, the RG 210 may communicate with a Key Server 340 using a link 356, which may be electrical, optical, or wireless, to obtain a shared key between the UE 220 and the RG 210. The Key Server 340 may be coupled to the L2 Edge 230 or the network of the L2 Edge 230 and may comprise a Key Distributor 344, which may be configured to assign secure session keys. Specifically, the KaY 214 may complete with the KaY 224 a first portion of a key exchange based on the IEEE 802.1 AF protocol and the Key Distributor 314 may complete with the Key Distributor 344 a second portion of the key exchange based on another authentication protocol, such as a control and provisioning of wireless access points (CAPWAP) protocol. For instance, the KaY 214 and the KaY 224 may exchange a plurality of MKA PDUs using the connection 255 and the IEEE 802.1 AF protocol to authenticate the UE 220. Hence, the KaY 214 may request, via the Key Distributor 314, and receive at least one key from the Key Distributor 344 using the CAPWAP protocol and the link 356. Hence, the KaY 214 may receive the key and share it with the KaY 224.

The CAPWAP protocol may be an interoperable protocol between the RG 210 and the Key Server 340, which is independent of a specific wireless technology between the RG 210 and the UE 220. As such, elements of the CAPWAP protocol may be designed to accommodate the specific needs of a wireless technology in a standard way. For instance, the CAPWAP protocol may support an IEEE 802.11 Wireless LAN (WLAN) based network coupled to or comprising the L2 Edge 230. In an embodiment, the KaY 214 and the Key Distributor 344 may exchange a plurality of L2 wireless data and management frames and use an Internet Key Exchange (IKE) or similar protocol to handle negotiation to generate encryption and authentication keys.

FIG. 4 shows a table illustrating a plurality of packet types 400, which may be forwarded between the RG and the UE or between the RG and the L2 Edge, or both. Specifically, the EAPOL packets may comprise a packet type, in addition to other fields, such as a protocol version, a packet body length, and a packet body. The packet type may have a length equal to about one octet that indicates the type of the PDU comprising the packet field. The table shows a plurality of packet types 410 for the PDUs, a plurality of corresponding values 420 (or octets), which may indicate each packet type, and plurality of recipient entities 430, which may receive each packet type.

For instance, the packet types may comprise an EAP packet, an EAPOL Start, and an EAPOL Logoff, which may be received by the PAE. The EAP packet may be assigned a value equal to about 00000000 and may indicate a payload PDU. The EAPOL Start may be assigned a value equal to about 00000001 and may indicate a first PDU in a sequence or stream of transmitted PDUs. The EAPOL Logoff may be assigned a value equal to about 00000010 and may indicate a last PDU in a sequence or stream of transmitted PDUs. The first and last PDUs may comprise no payload or no packet body. Additionally, the packet types may comprise an EAPOL Key, an EAPOL Encapsulated Alerting Standards Forum (ASF) Alert, and an EAPOL MKA, which may be received as determined by a Descriptor type in the packet, and ASF helper or server, and a KaY, respectively. The EAPOL Key may be assigned a value equal to about 00000011 and may indicate a key descriptor PDU. The EAPOL Encapsulated ASF Alert may be assigned a value equal to about 00000100 and may indicate an alert PDU. The EAPOL MKA may be assigned a value equal to about 00000101 and may indicate an MKA PDU.

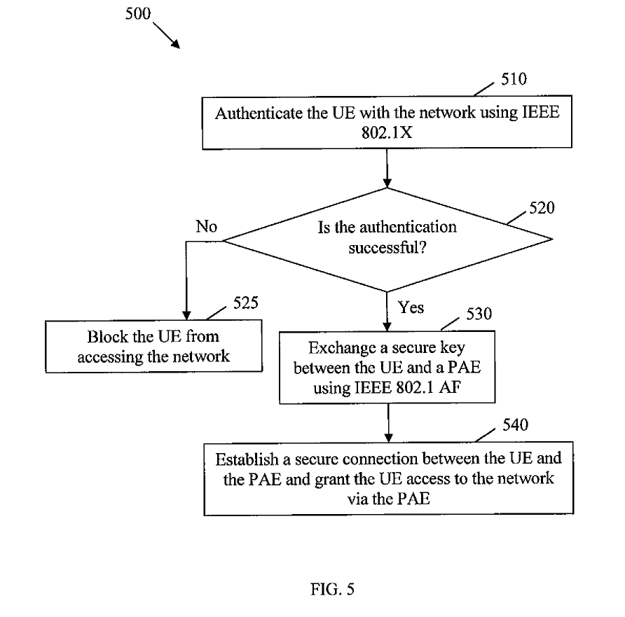

FIG. 5 illustrates an embodiment of an IEEE 802.1 AF and IEEE 802.1X interworking method 500, which may provide IEEE 802.1 AF authentication to a UE to access a network configured for IEEE 802.1X authentication. Specifically, the IEEE 802.1 AF and IEEE 802.1X interworking method 500 may provide the UE access to the network by authenticating the UE and sharing a key between the UE and a port entity, such as a PAE, that communicates with the network. The IEEE 802.1 AF and IEEE 802.1X interworking method 500 may start at block 510, where the UE may be authenticated with the network using the IEEE 802.1X protocol. For instance, the PAE may exchange EAPOL PDUs comprising the authentication and authorization information between the UE and the network. At block 520, the IEEE 802.1 AF and IEEE 802.1X interworking method 500 may verify whether the authentication is successful, for instance whether an authentication server at the network authorizes access to the UE. The IEEE 802.1 AF and IEEE 802.1X interworking method 500 may proceed to block 530 if the condition of block 520 is met. Otherwise, the IEEE 802.1 AF and IEEE 802.1X interworking method 500 may proceed to block 525 to block the UE from accessing the network, for instance by opening a switch or deactivating a port at the PAE along an access path to the network.

Alternatively, at block 530, the IEEE 802.1 AF and IEEE 802.1X interworking method 500 may exchange a secure key between the UE and the PAE using the IEEE 802.1 AF protocol. For instance, the MKA protocol may be implemented to share a secure key between the UE and a KaY at the PAE. The IEEE 802.1 AF and IEEE 802.1X interworking method 500 may then proceed to block 540, where a secure connection between the UE and the PAE may be established using the shared key and the UE is granted access to the network via the PAE.

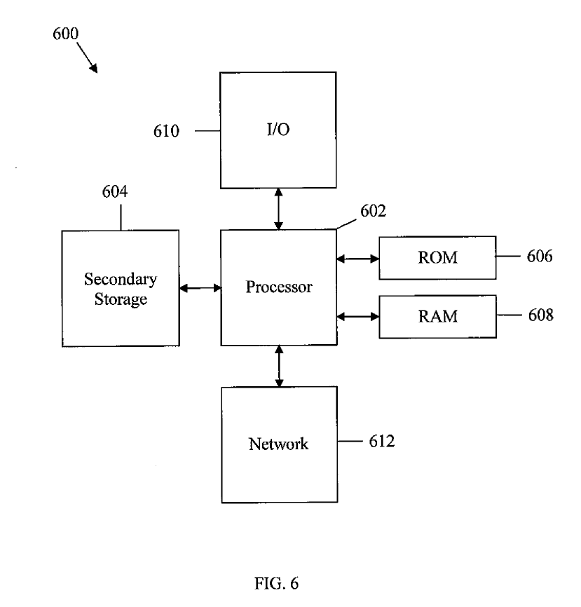

The network components described above may be implemented on any general-purpose network component, such as a computer or network component with sufficient processing power, memory resources, and network throughput capability to handle the necessary workload placed upon it. FIG. 6 illustrates a typical, general-purpose network component 600 suitable for implementing one or more embodiments of the components disclosed herein. The network component 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips, or may be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RAM 608 is used to store volatile data and perhaps to store instructions. Access to both ROM 606 and RAM 608 is typically faster than to secondary storage 604.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a supplicant proxy port authorization entity (PAE) configured to communicate with a user equipment (UE) and a network,
wherein the supplicant proxy PAE causes a communication path to forward or block communications between the UE and the network.

2. The apparatus of claim 1 further comprising a switch located on the communications path and controlled by the supplicant proxy PAE, wherein the switch is opened to block the UE access to the network if authentication of the UE fails, and wherein the switch is closed to grant the UE access to the network if authentication of the UE is successful.

3. The apparatus of claim 1, wherein the supplicant proxy PAE communicates with a Layer two (L2) Edge.

4. The apparatus of claim 3, wherein the L2 Edge comprises:
a PAE; and
an authentication, authorization, and accounting (AAA) client coupled to the PAE,
wherein the PAE communicates with the AAA client and the supplicant proxy PAE to authenticate the UE.

5. The apparatus of claim 4, wherein the L2 Edge further comprises a switch located on the communications path and controlled by the AAA client, wherein the switch is opened to block the UE access to the network if authentication of the UE fails, and wherein the switch is closed to grant the UE access to the network if authentication of the UE succeeds.

6. The apparatus of claim 1 further comprising a key agreement entity (KaY) and a media access control (MAC) security entity (SecY) that establish a secure session with the UE using a shared key.

7. The apparatus of claim 6, wherein the UE comprises a PAE that communicates with the supplicant proxy PAE, a second KaY that communicates with the KaY, and a second SecY that communicates with the SecY.

8. The apparatus of claim 6, wherein the supplicant proxy PAE promotes authentication for the UE to access the network using an Institute of Electrical and Electronics Engineers (IEEE) 802.1X protocol, and wherein the KaY promotes exchanging a shared key with the UE using an IEEE 802.1 AF protocol to establish secured communications.

9. The apparatus of claim 8, wherein the KaY communicates with a Key Server to obtain the shared key.

10. The apparatus of claim 9, wherein the Key Server comprises a Key Distributor that forwards the shared key to the KaY using a control and provisioning of wireless access points (CAPWAP) protocol.

11. The apparatus of claim 1, wherein the supplicant proxy PAE is associated with a plurality of ports comprising a trusted port and an untrusted port, wherein the trusted port is connected via authenticated connections to a trusted UE, and wherein the untrusted port is reserved for wireless connection to an unauthenticated UE.

12. A network component comprising:
at least one processor configured to implement a method comprising:
authenticating a user equipment (UE) with a network using an Institute of Electrical and Electronics Engineers (IEEE) 802.1X protocol; and
exchanging a secure key with the UE using an IEEE 802.1 AF protocol.

13. The network component of claim 12, wherein the UE is authenticated and the secure key is shared by a supplicant proxy port authorization entity (PAE) in communication with the UE and the network.

14. The network component of claim 13, wherein authenticating the UE comprises exchanging a plurality of Extensible Authentication Protocol over Local Area Network (EAPOL) protocol data units (PDUs) with the UE and the network.

15. The network component of claim 13, wherein exchanging the secure key comprises exchanging a plurality of MKA protocol data units (PDUs) with the UE using a media access control (MAC) security key agreement (MKA) protocol.

16. The network component of claim 12, wherein the network is not configured to exchange the secure key with the UE using the IEEE 802.1 AF protocol.

17. The network component of claim 12, wherein the network is an Internet Protocol (IP) network.

18. A method comprising:
authenticating a user equipment (UE) configured for a first authentication protocol with a network configured for a second authentication protocol using a port entity configured for the first authentication protocol and the second authentication protocol; and
securing the UE's access to the network by completing a security key agreement using the first authentication protocol.

19. The method of claim 18, wherein the port entity receives an Extensible Authentication Protocol (EAP) packet, an EAP over Local Area Network (EAPOL) Start, an EAPOL Logoff, or combinations thereof.

20. The method of claim 19, wherein the port entity transmits an EAPOL Key packet, an EAPOL Encapsulated Alerting Standards Forum (ASF) Alert packet, an EAPOL MKA packet, or combinations thereof.
